(19) United States
(12) Patent Application Publication
(10) Pub. No.: US 2020/0342047 A1
(43) Pub. Date: Oct. 29, 2020

(54) METHOD OF PROCESSING BAND-LIMITED S-PARAMETER FOR TRANSIENT ANALYSIS

(71) Applicants: Jae Yong CHO, Seongnam (KR); HUWIN CO., LTD., Seongnam (KR)

(72) Inventors: Jae Yong CHO, Suwon (KR); Seungil JEUNG, Seongnam (KR)

(73) Assignee: HUWIN CO., LTD.

(21) Appl. No.: 16/519,226

(22) Filed: Jul. 23, 2019

(30) Foreign Application Priority Data
Apr. 29, 2019 (KR) 10-2019-0049758

(51) Int. Cl. G06F 17/17

(52) U.S. Cl. CPC G06F 17/17

(57) ABSTRACT

The present invention relates to a method of processing a band-limited S-parameter for a transient analysis, the method including removing a propagation delay time of a band-limited S-parameter signal; generating an interpolation function for a real part of the band-limited S-parameter signal; generating an extrapolation function for the real part of the band-limited S-parameter signal; and generating an extended S-parameter signal with the interpolation function and the extrapolation function. Accordingly, by extending the interpolation function and the extrapolation function ensuring continuity with the real part, there is an advantage that the causality problem does not occur in the impulse response of the extended S-parameter signal.

### CROSS REFERENCE TO RELATED APPLICATION

The present application claims priority to Korean Patent Application No. 10-2019-0049758, filed Apr. 29, 2019, the entire content of which is incorporated herein for all purposes by this reference.

### BACKGROUND OF THE INVENTION

### Field of the Invention

The present invention relates to a method of processing a band-limited S-parameter for a transient analysis and, more particularly, to a method of processing a band-limited S-parameter to analyze a transient using a band-limited S-parameter.

### Description of the Related Art

In order to analyze a transient of a passive network using an S-parameter, there is a method of transforming the S-parameter into an equivalent circuit and performing the circuit simulation on the equivalent circuit.

There is an advantage that such circuit simulation is performed on the S-parameter in which measurement bandwidth is limited, but there is a disadvantage that the equivalent circuit transform process is complicated.

On the other hand, there is a method of transforming an S-parameter into an impulse response and performing a convolution operation on the impulse response and the input signal to analyze a transient. The method has an advantage that the S-parameter is simply transformed into an impulse response by performing an inverse fast Fourier transform (IFFT).

However, in the case of the S-parameter in which the measurement bandwidth is limited, since a transform error is caused due to a causality problem as shown in FIG. 1, there is an increasing need to avoid the causality problem in the S-parameter in which the measurement bandwidth is limited.

### DOCUMENTS OF RELATED ART

(Patent Document 1) U.S. Patent Application Publication No. 2008/0281893 (Optimization of spectrum extrapolation for causal impulse response calculation using Hilbert transform)

### SUMMARY OF THE INVENTION

Accordingly, the present invention has been made keeping in mind the above problems occurring in the prior art, and an object of the present invention is to provide a method of transforming a band-limited S-parameter into an impulse response to analyze a transient, by which the corresponding signal is extended in the low frequency band and the high frequency band so that the causality problem does not occur when performing an inverse fast Fourier transform on the S-parameter in which the measurement bandwidth is limited.

A method of processing a band-limited S-parameter for a transient analysis in a passive network according to an embodiment of the present invention includes: removing a propagation delay time of the band-limited S-parameter signal; generating an interpolation function for a real part of the band-limited S-parameter signal; generating an extrapolation function for the real part of the band-limited S-parameter signal; and generating an extended S-parameter signal with the interpolation function and the extrapolation function.

The method of processing the band-limited S-parameter for a transient analysis according to an embodiment of the present invention has an advantage that the causality problem does not occur when the low frequency band and the high frequency band of the band-limited S-parameter signal are extended so that the extended S-parameter signal is transformed into the impulse response by performing an inverse fast Fourier transform. Accordingly, there are advantages that the transient can be analyzed without a complicated equivalent circuit transform process, and the causality problem does not occur upon analyzing the transient for the band-limited S-parameter.

### BRIEF DESCRIPTION OF THE DRAWINGS

The accompanying drawings with respect to the specification illustrate preferred embodiments of the present invention and serve to further convey the technical idea of the present invention together with the description of the present invention given below, and accordingly the present invention should not be construed as limiting only to those described in the drawings, in which:

FIG. 1 is a diagram illustrating that a causality problem occurs when an S-parameter in which measurement bandwidth is limited is transformed into an impulse response in the related art;

FIG. 2 is a flowchart illustrating a method of processing a band-limited S-parameter (hereinafter, referred to as “band-limited S-parameter processing method”) for a transient analysis, according to an embodiment of the present invention;

FIG. 3 is a diagram illustrating a band-limited S-parameter measurement signal to which the band-limited S-parameter processing method is applied for a transient analysis and extension signals therefor, according to an embodiment of the present invention;

FIG. 4 is a diagram illustrating a band-limited S-parameter measurement signal to which the band-limited S-parameter processing method is applied for a transient analysis and separated interpolation function and extrapolation function therefor, according to an embodiment of the present invention;

FIG. 5 is a flowchart illustrating a propagation delay time removing step of the band-limited S-parameter processing method for a transient analysis according to an embodiment of the present invention;

FIG. 6 is a flowchart specifically illustrating a low frequency band extension step of the band-limited S-parameter processing method for a transient analysis, according to an embodiment of the present invention;

FIG. 7 is a flowchart specifically illustrating a high frequency band extension step of the band-limited S-parameter processing method for a transient analysis, according to an embodiment of the present invention; and

FIG. 8 show graphs illustrating an impulse response as the band-limited S-parameter processing method is applied for a transient analysis, according to an embodiment of the present invention.

### DETAILED DESCRIPTION OF THE INVENTION

Hereinafter, embodiments of the present invention will be described in detail with reference to the accompanying drawings so that those skilled in the art can easily carry out the present invention. The present invention may, however, be embodied in many different forms and should not be construed as limited to the embodiments set forth herein. In order to clearly illustrate the present invention, parts not related to the description are omitted, and similar parts are denoted by like reference characters throughout the specification.

A band-limited S-parameter processing method for transient analysis according to an embodiment of the present invention will now be described in detail with reference to the accompanying drawings.

In the description of the specification, the subject performing the action may be a processor that measures and processes the S-parameter for a transient analysis in a passive network and, as another example, a recording medium on which program performing the measurement and processing processes is recorded, or a device including the same.

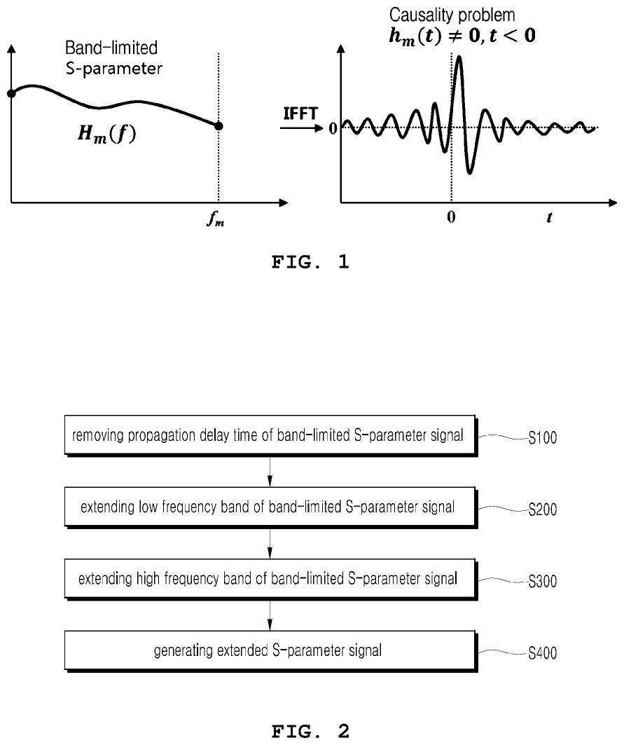

First, the band-limited S-parameter processing method for a transient analysis according to an embodiment of the present invention includes a step of removing a propagation delay time of a band-limited S-parameter signal (S100), a step of extending the low frequency band of the band-limited S-parameter signal (S200), a step of extending the high frequency band of the band-limited S-parameter signal (S300), and a step of generating the extended S-parameter signal (S400), as shown in FIG. 2.

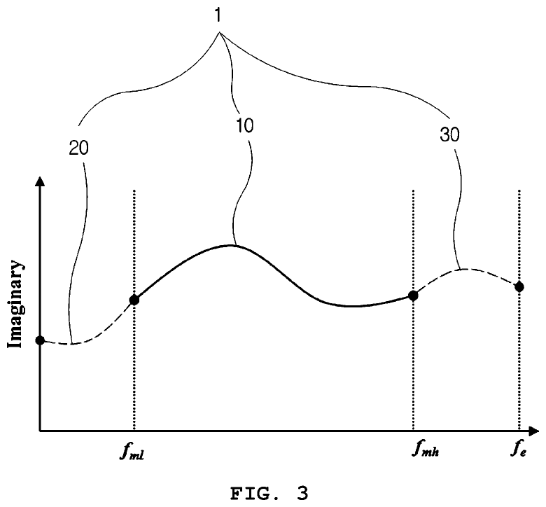

Considering an extension type of a signal referring to FIG. 3 when extending the low frequency band and the high frequency band of the band-limited S-parameter signal in the band-limited S-parameter processing method for a transient analysis according to an embodiment of the present invention, the band-limited S-parameter 10 is a S-parameter signal for which a frequency is measured, and an interpolation function 20 and an extrapolation function 30 are generated for the band-limited S-parameter 10 as the band-limited S-parameter processing method is performed for a transient analysis according to an embodiment of the present invention.

Here, the continuity between the interpolation function 20 and the extrapolated function 30 to be generated and an imaginary part of the measured band-limited S-parameter 10 is maintained, and the band-limited S-parameter 10 and the interpolation function 20 and the extrapolation function 30 that are continuous to the S-parameter signal 10 are added to generate the extended S-parameter signal 1 by performing the steps of FIG. 2.

Referring to FIG. 3, as the band-limited S-parameter 10 is measured in the frequency range of fₘₗ to fₘₕ, a signal ranging from the frequency 0 to the lowest frequency fₘₗ of the band-limited S-parameter 10 is generated in a step of extending the low frequency band of the band-limited S-parameter signal (S200), and a signal ranging from the highest frequency fₘₕ of the band-limited parameter 10 to the extended frequency fₑ is generated in the step of extending the high frequency band of the band-limited S-parameter signal (S300).

Accordingly, as the interpolation function 20 and the extrapolation function 30 are generated for the measured band-limited S-parameter signal 10, the lowest frequency of the S-parameter signal extends from fₘₗ to 0, and the highest frequency of the S-parameter signal extends from fₘₕ to fₑ.

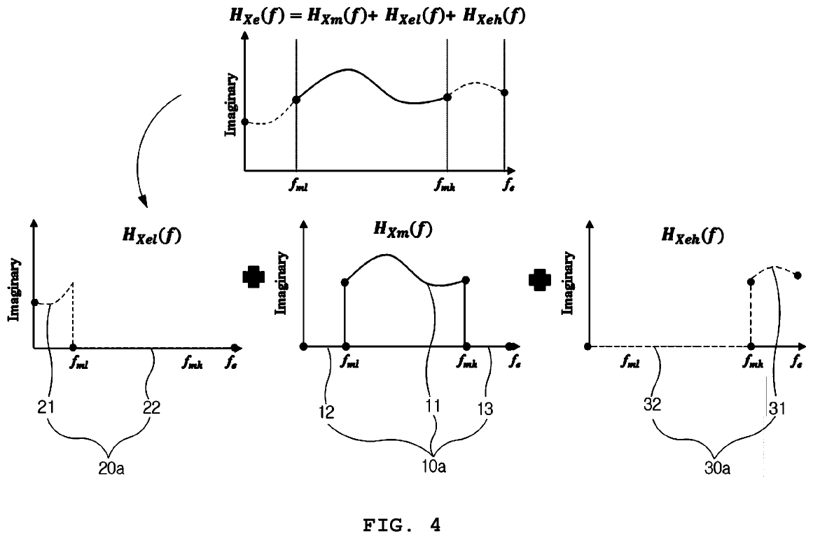

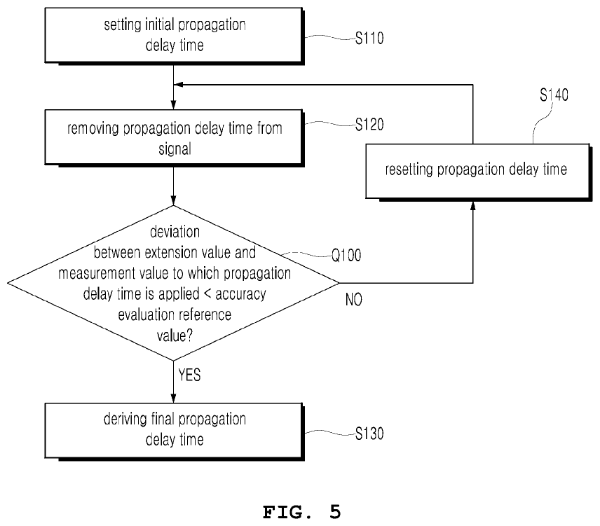

Here, the extended S-parameter signal H_{Xe}(f) 1 may be decomposed as shown in FIG. 4. Specifically, referring to FIG. 4, the extended S-parameter signal H_{Xe}(f) 1 is decomposed into an interpolation function part Hₓₑₗ(f) 20a, a band-limited S-parameter signal part H_{Xm}(f) 10a, and an extrapolation function part H_{Xeh}(f) 30a. The interpolation function part 20a may be regarded as a combination of a first part 21 having a response interpolated in the frequency range of 0 to fₘₗ and a second part 21 having a value of 0 in the frequency range of fₘₗ to fₑ.

The S-parameter signal part 10a may be regarded as a combination of a first part 12 having a value of zero in the frequency range of 0 to fₘₗ, a second part 11 having the measured response in the frequency range of fₘₗ to fₘₕ, and a third part 13 having a value of 0 in the frequency range of fₘₕ to fₑ.

In addition, the extrapolation function part 30a may be regarded as a combination of a first part 32 having a value of 0 in the frequency range of 0 to fₘₗ and a second part 31 having an extrapolated response in the frequency range of fₘₕ to fₑ.

Referring back to FIG. 2, the band-limited S-parameter processing method for a transient analysis according to an embodiment of the present invention will be described. In the step of removing a propagation delay time of a band-limited S-parameter signal (S100), the propagation delay time of the band-limited S-parameter signal may be removed, whereby upon performing the Hilbert transform in the step of extending the low frequency and high frequency bands (S300), the accuracy thereof is improved because there is no propagation delay time in the frequency domain.

Referring to FIG. 5, the step of removing the propagation delay time of the band-limited S-parameter signal (S100) will be described in more detail. First, an initial propagation delay value τ_{Init} is set, in a step of setting an initial propagation delay time (S110).

$${τ}_{init} = ( - \frac{∠ {H}_{m} ( {f}_{mh} )}{2 π f} ) \qquad [ Equation 1 ]$$

In the above equation 1, Hₘ(fₘₕ) is a function of the frequency fₘₕ, that is, the frequency starting point fₘₕ of the high frequency band to be extended.

The initial propagation delay time value τ_{Init} set in the step S110 may be set as an estimated propagation delay time value τₑₛₜ, which is used in order to estimate the propagation delay time until the propagation delay time value is finally defined.

Next, in a step of removing the propagation delay time from the signal (S120), using the estimated propagation delay time value, initially set as the estimated propagation delay time value τₑₛₜ in the step S110 above, the propagation delay time is removed from the band-limited S-parameter signal as indicated in Equation 2 below.

H_{m_zd}(f)=Hₘ(f)e^{j2πf·τ}^{ₑₛₜ}=H_{Rm_zd}(f)+j·H_{Xm_zd}(f) [Equation 2]

Where, H_{m_zd}(f) in the left hand side is a function obtained by removing the propagation delay time from Hₘ(f), and the propagation delay time removal is performed by multiplying the Hₘ(f) function and e^{j2πf·τ}^{ₑₛₜ}.

In the above Equation 2, the function in which the propagation delay time is removed is defined by adding a real part function H_{Rm_zd}(f) of the function in which propagation delay time is removed and an imaginary part function H_{Xm_zd}(f) of the function in which the propagation delay time is removed.

Then, in a step of comparing a deviation between the extension value and the measurement value to which the propagation delay time is applied with the accuracy evaluation reference value (Q100), the accuracy evaluation reference value NMSEₜₕ is compared with the deviation between the extension value H_{Re_zd}(fᵢ) to which the estimated propagation delay time value is applied, that is, the value obtained by subtracting the estimated propagation delay time value from the extension value H_{Re}(fᵢ) and the measured value H_{Rm_zd}(fᵢ) to which the estimated propagation delay time value is applied, that is, the value obtained by subtracting the estimated propagation delay time value from the measurement value H_{Rm}(fᵢ), as indicated in Equation 3 below.

$${\sum }_{i = 1}^{V} \frac{{\vert {H}_{Re \_ zd} ( {f}_{i} ) - {H}_{Rm \_ zd} ( {f}_{i} ) \vert}^{2}}{{\vert {H}_{Rm \_ zd} ( {f}_{i} ) \vert}^{2}} < {NMSE}_{th} \qquad [ Equation 3 ]$$

Where, the left hand side is the deviation between H_{Re_zd}(fᵢ) and H_{Rm_zd}(fᵢ) and the right hand side is the accuracy evaluation reference value. In the preferred example, the accuracy evaluation reference value NMSEth is set to 0.01; i is a natural number starting from 1; and fᵢ, f₁, or fᵥ are calculated from the following Equation 4.

fᵢ=f₁+(i−1)·Δf

f₁=fₘₗ

f_{V}=fₘₕ [Equation 4]

Where, f is a predetermined period for the frequency of the measured S-parameter.

In Equation 3 and Equation 4 above, the values of NMSEₜₕ and f may be changed and should not limit the present invention.

In the determination step (Q100), when the deviation between the extension value and the measurement value to which the propagation delay time is applied is smaller than the accuracy evaluation reference value (Yes in FIG. 5), a step of deriving a final propagation delay time (S130) is performed from the following Equation 5.

τₚ=τₑₛₜ [Equation 5]

In step of deriving the final propagation delay time (S130) performed from Equation 5 above, the initial estimated propagation delay time value τₑₛₜ set as the initial propagation delay time value at the step of setting the initial propagation delay time value (S110), or the estimated propagation delay time value τₑₛₜ reset at the step of resetting the propagation delay time (S140) is set as the final propagation delay value τₚ.

Meanwhile, when the deviation between the extension value and the measurement value to which the propagation delay time is applied is not smaller than the accuracy evaluation reference value in the determination step (Q100), that is, greater than or equal to the accuracy evaluation reference value (No in FIG. 5), the propagation delay time is reset from Equation 6 below (S140), and then the step (S120) is performed again using the estimated propagation delay time value reset in the step S140.

[Equation 6]

τₑₛₜ=τₑₛₜ−Δτ

As shown in Equation 6 above, when resetting the estimated propagation delay time value, the estimated propagation delay time value is updated by subtracting τ from the predetermined estimated propagation delay time value, where the value of τ may be 0.1 nsec.

Since the step of resetting the propagation delay time (S140) is performed according to the determination result of the determination step Q100 which is provided in such a manner that the error of the band-extended response and the band-limited response is minimized as the accurate delay time is applied, the propagation delay time satisfying the determination step Q100 may be derived as the final propagation delay time, and accordingly, an accuracy of the Hilbert transform is improved when the band-limited S-parameter signal is extended.

According to the derivation process of the final propagation delay time (τₚ) described with reference to FIG. 5, in the step of removing propagation delay time of the band-limited S-parameter signal (S100) of FIG. 2, the propagation delay time of the band-limited S-parameter signal is removed using the derived final propagation delay time τₚ.

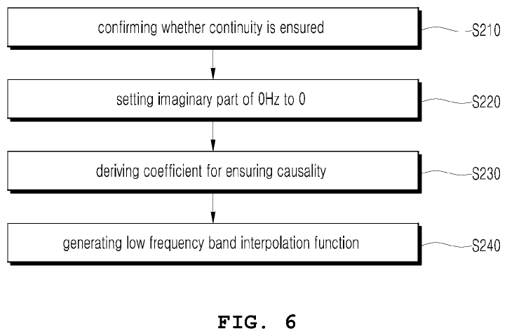

Next, the step of extending the low frequency band of the band-limited S-parameter signal (S200) will be described in detail with reference to FIG. 6. In the step of extending the low frequency band of the band-limited S-parameter signal (S200), a step of confirming whether the continuity between the band-limited S-parameter signal value and the interpolation function is ensured (S210) is first performed.

In this step S210, it is confirmed whether a part 10 of the measured band-limited S-parameter signal and the interpolation function 20 are continuous at the frequency fₘₗ of FIG. 3. Herein, it is confirmed that the continuity is ensured when the H_{Xel}(fₘₗ) value of the extended interpolation function 20 and the H_{Xm}(fₘₗ) value of the measured signal 10 are all equal to pₗ at the frequency fₘₗ of FIG. 3 as indicated in Equation 7 below.

$${H}_{Xel} ( {f}_{m l} ) = {H}_{Xm} ( {f}_{m l} ) = {p}_{l} \\ \frac{{dH}_{Xel} ( {f}_{m l} )}{df} = \frac{{dH}_{Xm} ( {f}_{m l} )}{df} = {q}_{l} \qquad [ Equation 7 ]$$

In Equation 7 above, values obtained by differentiating values of H_{Xel}(fₘₗ) at fₘₗ and H_{Xm}(fₘₗ) at fₘₗ by frequency, respectively, are set equal to qₗ so that the continuity between the real part 10 of the band-limited S-parameter signal and the interpolation function 20 is forced to be ensured. That is, it means that the values of H_{Xel}(fₘₗ) and H_{Xm}(fₘₗ) are continuous to each other at the point of fₘₗ.

Then, in a step of setting an imaginary part of 0 Hz to 0 (S220), an imaginary part value of the interpolation function is set to have a value of 0 at the point of 0 Hz by using the following Equation 8.

[Equation 8]

H_{Xel}(0)=H_{Xm}(0)=0

In this step S200, upon extending the low frequency band for the band-limited S-parameter signal, the imaginary part (y-axis in FIG. 3) obtained as a result of transforming the time waveform into frequency has a characteristic of origin symmetry with respect to the sampling frequency 0 Hz, so that the interpolation function 20 which is a low frequency band extension part is set as an odd function which is symmetrical to the origin as indicated in Equation 9 below.

$${H}_{Xel} ( f ) = {\sum }_{k = 1}^{K} {a}_{k} \cdot {f}^{2 k - 1} \qquad [ Equation 9 ]$$

Where, H_{Xel}(f) is a low frequency band extension interpolation function for frequency f; k in the right hand side is a natural number from 1 to K; and aₖ is a coefficient of a 2k-1th order polynomial function.

In this manner, when the interpolation function for extending the low frequency band is set as the odd function including the coefficients of aₖ, a step of deriving a coefficient for ensuring the causality (S230) is performed. The step S230 may be performed to satisfy the Kramers-Kroniq (k-k) relations, which is a causality establishment condition of the frequency response at the frequency point fᵢ at which the causality should be ensured.

According to this step S230, Equation 11 below is derived from the following Equation 10 which is an operation of confirming whether to satisfy the general K-K relations, so that it is confirmed whether to establish the K-K relations between the extended low frequency band interpolation function and the measured band-limited S-parameter.

$${H}_{R} ( {f}_{i} ) = HT \{ {H}_{X} ( f ) , {f}_{i} \} = \frac{1}{π} P {\int }_{- ∞}^{∞} \frac{{H}_{X} ( f )}{{f}_{i} - f} df \\ {H}_{X} ( {f}_{i} ) = - HT \{ {H}_{R} ( f ) , {f}_{i} \} = - \frac{1}{π} P {\int }_{- ∞}^{∞} \frac{{H}_{R} ( f )}{{f}_{i} - f} df \qquad [ Equation 10 ]$$

Where, H_{R}(fᵢ) is an real value function at frequency fᵢ; HT{ } is the Hilbert Transform; Hₓ(f) is an imaginary part function at frequency f; and P is a Cauchy principle value.

H_{Rm}(fᵢ))=HT{H_{Xm}(f)+H_{Xel}(f)+H_{Xeh}(f),fᵢ}(fₘₗ≤fᵢ≤fₘₕ) [Equation 11]

Where, H_{Rm}(fᵢ) is a real value of the measured band-limited S-parameter at frequency fᵢ; H_{Xm}(f) is an imaginary part value of the measured band-limited S-parameter at frequency f; Hₓₑₗ(f) is an imaginary part value of the low frequency band extended interpolation function at frequency f; H_{Xeh}(f) is an imaginary part value of the high frequency band extended extrapolation function at frequency f; fₘₗ is a lowest frequency of the measured band-limited S-parameter; and fₘₕ is a highest frequency of the measured band-limited S-parameter.

Therefore, Equation 12 below is derived from Equation 10 and Equation 11 above in the step of deriving the coefficient for ensuring the causality (S230), and Equation 13 below is derived by applying Equation 9 to Equation 12 to derive the coefficient aₖ satisfying the K-K relation.

$$\begin{matrix}{H}_{Rm} ( {f}_{i} ) = HT \{ {H}_{Xm} ( f ) + {H}_{Xel} ( f ) + {H}_{Xeh} ( f ) , {f}_{i} \} , \{ {f}_{m l} \leq {f}_{i} \leq {f}_{mh} ) \\ HT \{ {H}_{Xel} ( f ) , {f}_{i} \} + HT \{ {H}_{Xeh} ( f ) , {f}_{i} \} = {H}_{Rm} ( {f}_{i} ) - HT \{ {H}_{Xm} ( f ) , {f}_{i} \} & [ Equation 12 ] \\ {\sum }_{k = 3}^{K} {a}_{k} \cdot {F}_{lk} ( {f}_{i} ) + {\sum }_{j = 3}^{J} {b}_{j} \cdot {F}_{hf} ( {f}_{i} ) = C ( {f}_{i} ) \\ {F}_{lk} ( {f}_{i} ) = HT \{ {f}^{2 k - 1} - ( k - 1 ) \cdot {f}_{m l}^{2 ( k - 2 )} \cdot {f}^{3} + ( k - 2 ) \cdot {f}_{m l}^{2 ( k - 1 )} \cdot f , {f}_{i} \} \\ {F}_{hj} ( {f}_{i} ) = HT \{ {( f - {f}_{e} )}^{2 j - 1} - ( j - 1 ) \cdot {f}_{b}^{2 ( j - 2 )} \cdot {( f - {f}_{e} )}^{3} + ( j - 2 ) \cdot {f}_{b}^{2 ( j - 1 )} \cdot ( f - {f}_{e} ) , {f}_{i} \} \\ C ( {f}_{i} ) = {H}_{Hm} ( {f}_{i} ) - HT \{ {H}_{Xm} ( f ) , {f}_{i} \} - HT \{ ( \frac{q \text{?}}{2 {f}_{m l}^{2}} - \frac{p \text{?}}{2 {f}_{m l}^{3}} ) {f}^{3} - ( \frac{q \text{?}}{2} - \frac{3 p \text{?}}{2 {f}_{m l}} ) f + ( \frac{q \text{?}}{2 {f}_{b}^{2}} + \frac{p \text{?}}{2 {f}_{b}^{3}} ) {( f - {f}_{e} )}^{3} - ( \frac{q \text{?}}{2} + \frac{p \text{?}}{2 {f}_{b}} ) ( f - {f}_{e} ) , {f}_{i} \} \\ \text{?} \text{indicates text missing or illegible when filed} & [ Equation 13 ]\end{matrix}$$

Where, k is a natural number ranging from 3 to K, j is a natural number ranging from 3 to J; Fₗₖ(fᵢ) is a low frequency band extension function at frequency fᵢ; Fₕⱼ(fᵢ) is a high frequency band extension function at frequency fᵢ; and C(fᵢ) is a constant. Herein, the coefficient aₖ of the low frequency band extension function H_{Xel}(f) and the coefficient bⱼ of the high frequency band extension function H_{Xeh}(f) may be simultaneously derived.

Equation 13 above is solved as Equation 14 below, in which the frequency index may be defined to be the same as defined in Equation 4 above.

$$[ X ] = [ \begin{matrix}\begin{matrix}{F}_{l 3} ( {f}_{1} ) & {F}_{l 4} ( {f}_{1} )\end{matrix} & \begin{matrix}… & {F}_{lK} ( {f}_{1} ) & {F}_{h 3} ( {f}_{1} ) & {F}_{h 4} ( {f}_{1} )\end{matrix} & … & {F}_{hJ} ( {f}_{1} ) \\ \begin{matrix}{F}_{l 3} ( {f}_{2} ) & {F}_{l 4} ( {f}_{2} )\end{matrix} & \begin{matrix}… & {F}_{lK} ( {f}_{2} ) & {F}_{h 3} ( {f}_{2} ) & {F}_{h 4} ( {f}_{2} )\end{matrix} & … & {F}_{hJ} ( {f}_{2} ) \\ & ⋮ & & \\ \begin{matrix}{F}_{l 3} ( {f}_{V} ) & {F}_{l 4} ( {f}_{V} )\end{matrix} & \begin{matrix}… & {F}_{lK} ( {f}_{V} ) & {F}_{h 3} ( {f}_{V} ) & {F}_{h 4} ( {f}_{V} )\end{matrix} & … & {F}_{hJ} ( {f}_{V} )\end{matrix} ] \\ [ A ] = {[ \begin{matrix}{a}_{3} & {a}_{4} & … & {a}_{K} & {b}_{3} & {b}_{4} & … & {b}_{J}\end{matrix} ]}^{T} \\ [ Y ] = {[ \begin{matrix}C ( {f}_{1} ) & C ( {f}_{2} ) & … & C ( {f}_{V} )\end{matrix} ]}^{T} \qquad [ Equation 14 ]$$

Thus, the structure of Equation 14 above is [X][A]=[Y], in which the product of [A] which is a set of coefficients and [X] which is a set of frequency polynomials to which the coefficient is applied is [Y] which is a set of frequency polynomials to which the coefficient is not applied, so that a least square error technique may be applied. Therefore, [A] which is a set of coefficients aₖ is derived by applying following Equation 15.

[Â]=([X]^{H}[X])⁻¹[X]^{H}[Y] [Equation 15]

When the set of coefficients aₖ is derived, a low frequency band extended interpolation function satisfying all of the above steps S210, S220, and S230 is derived as in Equation 16 below, in a step of generating the low frequency band interpolation function (S240) to be performed next.

$${H}_{Xel} ( f ) = \{ \begin{matrix}{\sum }_{k = 3}^{K} {a}_{k} \cdot \{ \begin{matrix}{f}^{2 k - 1} - ( k - 1 ) \cdot {f}_{m l}^{2 ( k - 2 )} \cdot {f}_{3} + \\ ( k - 2 ) \cdot {f}_{m l}^{2 ( k - 1 )} \cdot f\end{matrix} \} + \\ \begin{matrix}( \frac{{q}_{l}}{2 {f}_{m l}^{2}} - \frac{{p}_{l}}{2 {f}_{m l}^{3}} ) {f}^{3} - ( \frac{{q}_{l}}{2} - \frac{3 {p}_{l}}{2 {f}_{m l}} ) f , & ( 0 \leq f \leq {f}_{m l} ) \\ 0 , , & else\end{matrix}\end{matrix} \qquad [ Equation 16 ]$$

Herein, the low frequency band extended interpolation function H_{Xel}(f) is defined as the function summarized in Equation 16 above in the frequency range of 0 to fₘₗ, which is a low frequency band extension range of the band-limited S-parameter, and has a value of 0 for else frequency range, as described with reference to FIG. 4.

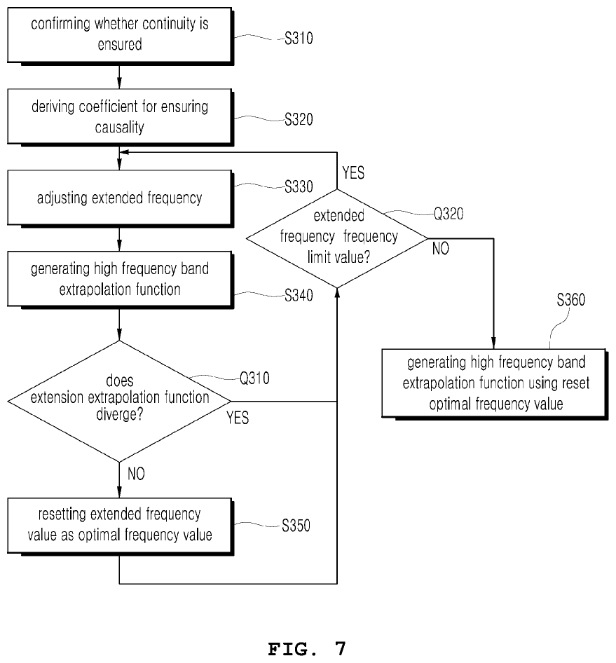

The step of extending the high frequency band of the band-limited S-parameter signal (S300) will be described in detail with reference to FIG. 7. The step of extending the high frequency band of the band-limited S-parameter signal (S300) is performed to include a step of confirming whether to ensure the continuity (S310) in the same manner as in the low frequency band extension step (S200), and a step of deriving coefficient for ensuring a causality (S320), a step of adjusting the extended frequency (S330), a step of generating the high frequency band extrapolation function (S340), and a step of determining whether the extension extrapolation function diverges (Q310).

In step S310 of confirming whether to ensure the continuity, it is confirmed whether or not the part 10 of the measured band-limited S-parameter signal and the extrapolation function 30 are continuous at fₘₕ of FIG. 3. More specifically, it is confirmed that the continuity is ensured when the H_{Xeh}(fₘₕ) value of the extension extrapolation function 30 and the H_{Xm}(fₘₕ) value of the measured signal 10 are all equal to pₕ at the frequency fₘₕ of FIG. 3, as indicated in Equation 17 below.

$${H}_{Xeh} ( {f}_{m h} ) = {H}_{Xm} ( {f}_{mh} ) = {p}_{h} \\ \frac{{dH}_{Xeh} ( {f}_{mh} )}{df} = \frac{{dH}_{Xm} ( {f}_{m h} )}{df} = {q}_{h} \qquad [ Equation 17 ]$$

Herein, values obtained by differentiating values of H_{Xeh}(fₘₕ) in fₘₗ and H_{Xm}(fₘₕ) in fₘₕ by frequency, respectively, are set equal to qₕ, so that the continuity between the real part 10 of the band-limited S-parameter signal and the extrapolation function 30 is forced to be ensured.

In the step S300, the extrapolation function 30 is set as a 2J-1th order polynomial function, which is an odd function as indicated in Equation 18 below, upon extending the high frequency band for the band-limited S-parameter signal.

$${H}_{Xeh} ( f ) = {\sum }_{j = 1}^{J} {b}_{j} \cdot {( f - {f}_{e} )}^{2 j - 1} \qquad [ Equation 18 ]$$

Where, H_{Xeh}(f) is a high frequency band extension extrapolation function for frequency f; j in the right hand side is a natural number ranging from 1 to J; and bⱼ is a coefficient of 2j-1th order polynomial function.

In this manner, when the extrapolation function for extending the high frequency band is set as an odd function including the coefficients of bⱼ, the step of deriving the coefficients for ensuring the causality (S320) in the step S300 is performed. Even though not described in detail in the step S320, the step S320 may be performed to be the same as in the step of deriving coefficient for ensuring the causality (S230) in FIG. 6 according to Equations 10 to 16, but the present invention is not limited thereto.

Then, the step of adjusting the extended frequency (S330) is to adjust an extended frequency fₑ of the extrapolation function 30 extended for the high frequency band. The step is performed with the following Equation 19.

fₑ=fₘₕ+Δf [Equation 19]

When the step of adjusting the extended frequency (S330) performed by Equation 19 is initially performed, the extended frequency fₑ is set to a value obtained by adding a value of f to the fₘₕ once. However, it is possible to update the extended frequency, by repetitively performing the step of determining the accuracy of the extended frequency, the step of determining whether the extrapolation function diverges, and the adjusting step of Equation 19 above according to whether the limit value of the extended frequency is satisfied.

Next, in the step of generating the high frequency band extrapolation function (S340), a high frequency band extrapolation function is generated using the following Equation 20.

$${H}_{Xeh} ( f ) = \{ \begin{matrix}{\sum }_{j = 3}^{J} {b}_{j} \cdot \{ \begin{matrix}{( f - {f}_{e} )}^{2 j - 1} - ( j - 1 ) \cdot {f}_{b}^{2 ( j - 2 )} \cdot \\ {( f - {f}_{e} )}^{3} + ( j - 2 ) \cdot {f}_{b}^{2 ( j - 1 )} \cdot \\ ( f - {f}_{e} )\end{matrix} \} + \\ \begin{matrix}\begin{matrix}( \frac{{q}_{h}}{2 {f}_{b}^{2}} + \frac{{p}_{h}}{2 {f}_{b}^{3}} ) {( f - {f}_{e} )}^{3} - \\ ( \frac{{q}_{h}}{2} + \frac{3 {p}_{h}}{2 {f}_{b}} ) ( f - {f}_{e} )\end{matrix} , & ( {f}_{mh} \leq f \leq {f}_{e} ) \\ 0 , & else\end{matrix}\end{matrix} \\ where , {f}_{b} = {f}_{e} - {f}_{mh} \qquad [ Equation 20 ]$$

Herein, the high frequency band extended interpolation function H_{Xeh}(f) is defined as the above summarized function in the frequency range of fₘₕ to fₑ, which is the high frequency band extension range of the band-limited S-parameter, and has a value of 0 as described with reference to FIG. 4 for else frequency range.

Then, in the step of determining whether the extension extrapolation function diverges (Q310), it is determined whether the extension extrapolation function diverges from the function of the following Equation 21, in order to prevent the extrapolation function value from diverging at the extended frequency fₑ to become a large value that violates the characteristics of the passive network, and to have a form converging in the direction of 0.

max(|H_{e_zd}(f)|)<Magₘₐₓ [Equation 21]

Where, |He_ze(f)| is an absolute value of the extension function value at which the propagation delay is removed at frequency f; max( ) is the function that calculates the maximum value; and the initial value of Magₘₐₓ is continuously updated, that is, Max(|Hₘ(f)|), (fₘₗ<=fᵢ<fₘₕ).

When it is determined that the extension extrapolation function does not diverge in the determination step (Q310) performed by Equation 21 (No in FIG. 7), a step of resetting the extended frequency fₑ value as an optimal frequency value fₒₚₜ (S350) is performed.

The above step S350 may be performed from Equation 22 below.

$${Mag}_{ma x} = max ( \vert {H}_{e \_ zd} ( f ) \vert ) \\ {f}_{opt} = {f}_{e} \qquad [ Equation 22 ]$$

On the other hand, when it is determined that the extension extrapolation function diverges in the determination step (Q310) (Yes in FIG. 7), a step of determining whether the extended frequency is equal to or less than the frequency limit value (Q320) is performed.

In the determining step Q320, it is determined whether the extended frequency fₑ value adjusted in the step of adjusting the extended frequency (S330) is equal to or smaller than the frequency limit value f_{e_max}, in which the determining step Q320 is performed until the extended frequency fₑ value exceeds the frequency limit value.

According to an embodiment of the present invention, when the extended frequency fₑ is equal to or less than the frequency limit value f_{e_max} (Yes in FIG. 7), the step of adjusting the extended frequency (S330) and the step of generating the high frequency band extrapolation function (S340) or step of resetting the extended frequency value as the optimal frequency value (S350) are performed. On the other hand, when the extended frequency fₑ exceeds the frequency limit value f_{e_max} (No in FIG. 7), the step of generating the high frequency band extrapolation function (S360) is performed using the reset optimal frequency value.

In the above step S360, the high frequency band extrapolation function may be implemented by applying the optimal frequency value to Equation 20 above.

According to an embodiment of the present invention, although not shown in the drawing, in the step of extending high frequency band (S300) described with reference to FIG. 7, it is possible to further perform a step of determining the accuracy by comparing the deviation between the extension value and the measurement value described in the propagation delay removal in FIG. 5 with a reference value. Herein, the step may be performed before the step of determining whether or not the extension extrapolation function diverges (Q310). In the case where the deviation is equal to or less than the reference value, the step of determining whether or not the extension extrapolation function diverges (Q310) is performed, and otherwise, a step of comparing the extended frequency of FIG. 7 with the frequency limit value (Q320) is performed

Referring back to FIG. 2, in the step (S400) of generating an extended S-parameter signal, which is a final step of the method of processing the band-limited S-parameter for a transient analysis according to an embodiment of the present invention, signals including a low frequency band extension interpolation function, the measured S-parameter signal, and the high frequency band extension extrapolation function are derived as indicated in Equation 23 below.

H_{Xe_zd}(f)=NIIEM{H_{m_zd}(f),f_{e_opt},K,J},(0≤f≤fₑ)

H_{Re_zd}(f)=HT{H_{Xe_zd}(f′),f},(0≤f≤fₑ) [Equation 23]

Herein, H_{Xe_ze}(f) is a real part of extension function in which the propagation delay time is removed; H_{Re_zd}(f) is an imaginary part of the extension function in which the propagation delay time is removed; and NIIEM{ } function is the low frequency band and high frequency band extension related function, which is applied to the equations described in Equation 16 and Equation 20.

The band-limited S-parameter processing method for a transient analysis according to an embodiment of the present invention has an advantage that causality problems do not occur in the impulse response of the extended S-parameter signal, because interpolation and extrapolation functions are extended that ensure the continuity of the real part of the measured band-limited S-parameter signal, as described with reference to FIGS. 1 to 7.

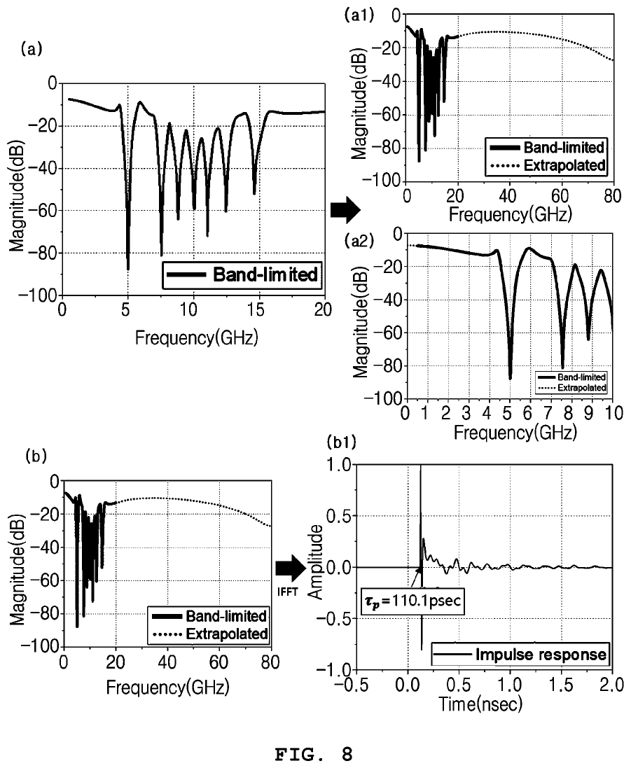

According to an example referring to FIG. 8, when measuring the S-parameter in a network structure having a form shown in (a) of FIG. 8 and having the frequency range of 0 to 20 GHz, the low frequency band of the S-parameter measured in the corresponding network is extended as shown in (a1) of FIG. 8 and the high frequency band thereof is extended as shown in (a2) of FIG. 8, so that the extended S-parameter signal is generated as shown in (b) of FIG. 8 and the impulse response derived by performing IFFT on the signal maintains causality as shown in (b1) of FIG. 8.

While the present invention has been particularly shown and described with reference to exemplary embodiments thereof, it is to be understood that the scope of rights of the present invention is not limited thereto, but various modifications and improvements performed by those skilled in the art using the basic concept of the present invention as defined in the claims are also within the scope of the present invention.

What is claimed is:

1. A method of processing a band-limited S-parameter for a transient analysis in a passive network, the method comprising:
removing a propagation delay time of a band-limited S-parameter signal;
generating an interpolation function for a real part of the band-limited S-parameter signal;
generating an extrapolation function for the real part of the band-limited S-parameter signal; and
generating an extended S-parameter signal with the interpolation function and the extrapolation function.

2. The method of claim 1, wherein the removing of the propagation delay time of the band-limited S-parameter signal includes:
setting an initial propagation delay time value;
removing the propagation delay time from the band-limited S-parameter signal;
comparing a deviation between an S-parameter extension value to which the propagation delay time is applied and an S-parameter measurement value to which the propagation delay time is applied with an accuracy evaluation reference value; and
performing either of deriving a final propagation delay time according to a result of the comparing of the deviation or resetting the propagation delay time.

3. The method of claim 2, wherein the comparing of the deviation is performed from an equation below:
$${\sum }_{i = 1}^{V} \frac{{\vert {H}_{Re \_ zd} ( {f}_{i} ) - {H}_{Rm \_ zd} ( {f}_{i} ) \vert}^{2}}{{\vert {H}_{Rm \_ zd} ( {f}_{i} ) \vert}^{2}} < {NMSE}_{th}$$
where, a left hand side is a deviation between H_{Re_zd}(fᵢ) and H_{Rm_zd}(fᵢ); H_{Re_zd}(fᵢ) is an extension value to which an estimated propagation delay time value is applied; H_{Rm_zd}(fᵢ) is an measurement value to which the estimated propagation delay time value is applied; a right hand side is the accuracy evaluation reference value and set to 0.01; and i is a natural number ranging from 1 to V.

4. The method of claim 1, wherein the generating of the interpolation function includes:
confirming whether continuity between a real part of the band-limited S-parameter signal and the interpolation function is ensured;
setting an imaginary part of 0 Hz of the interpolation function to zero;
deriving a coefficient for ensuring causality; and
generating a low frequency band interpolation function.

5. The method of claim 4, wherein the confirming whether the continuity between the real part of the band-limited S-parameter signal and the interpolation function is ensured is performed from an equation below:
$${H}_{Xel} ( {f}_{m l} ) = {H}_{Xm} ( {f}_{m l} ) = {p}_{l}$$
$$\frac{{dH}_{Xel} ( {f}_{m l} )}{df} = \frac{{dH}_{Xm} ( {f}_{m l} )}{df} = {q}_{l}$$
where, H_{Xel}(fₘₗ) is an interpolation function of the imaginary part of the band-limited S-parameter signal; H_{Xm}(fₘₗ) is a function of the imaginary part of the band-limited S-parameter signal; and fₘₗ is a lowest frequency of the band-limited S-parameter signal.

6. The method of claim 1, wherein the generating of the interpolation function for the real part of the band-limited S-parameter signal is performed so that the interpolation function is generated as an odd function that is symmetric with respect to an origin, which is a 2k-1th order polynomial function.

7. The method of claim 4, wherein the deriving of the coefficient for ensuring the causality is performed so as to derive the coefficient from an equation below:
$${\sum }_{k = 3}^{K} {α}_{k} \cdot {F}_{lk} ( {f}_{l} ) + {\sum }_{J = 3}^{J} {b}_{j} \cdot {F}_{hj} ( {f}_{i} ) = C ( {f}_{i} )$$
$${F}_{lk} ( {f}_{i} ) = HT \{ {J}^{2 k - 1} - ( k - 1 ) \cdot {f}_{m l}^{2 ( k - 2 )} \cdot {f}^{3} + ( k - 2 ) \cdot {f}_{m l}^{3 ( k - 1 )} \cdot \text{?} \}$$
$${F}_{hj} ( {f}_{i} ) = HT \{ {( f - {f}_{e} )}^{2 j - 1} - ( j - 1 ) \cdot {f}_{h}^{2 ( j - 2 )} \cdot {( f - {f}_{e} )}^{3} + ( j - 2 ) \cdot {f}_{h}^{2 ( j - 1 )} \cdot ( f - {f}_{e} ) , {f}_{i} \}$$
$$C ( {f}_{i} ) = {H}_{Rm} ( {f}_{i} ) - HT ( {H}_{Xm} ( f ) , {f}_{i} \} - HT \{ ( \frac{q \text{?}}{2 {f}_{m l}^{2}} - \frac{p \text{?}}{2 {f}_{m l}^{3}} ) {f}^{3} - ( \frac{q \text{?}}{2} - \frac{3 p \text{?}}{2 {f}_{m l}} ) f + ( \frac{q \text{?}}{2 {f}_{b}^{2}} + \frac{p \text{?}}{2 {f}_{b}^{3}} ) {( f - {f}_{e} )}^{3} - ( \frac{q \text{?}}{2} + \frac{3 p \text{?}}{2 {f}_{b}} ) ( f - {f}_{e} ) , {f}_{i} \}$$
$$\text{?} \text{indicates text missing or illegible when filed}$$
where, k is a natural number ranging from 3 to K; j is a natural number ranging from 3 to J; Fₗₖ(fᵢ) is a low frequency band extension function at frequency fᵢ; Fₕⱼ(fᵢ) is a high frequency band extension function at frequency fᵢ; and C(fᵢ) is a constant.

8. The method of claim 7, wherein the deriving of the coefficient for ensuring the causality is performed so as to calculate a set of coefficients aₖ as [A] by applying an LSE technique.

9. The method of claim 4, wherein the generating of the low frequency band interpolation function is performed so as to be defined by an equation below:
$${H}_{Xel} ( f ) = \{ \begin{matrix}{\sum }_{k = 3}^{K} {a}_{k} \cdot \{ {f}^{2 k - 1} - ( k - 1 ) \cdot {f}_{m l}^{2 ( k - 2 )} \cdot {f}^{3} + ( k - 2 ) \cdot {f}_{m l}^{2 ( k - 1 )} \cdot f \} + \\ \begin{matrix}( \frac{{q}_{l}}{2 {f}_{m l}^{2}} - \frac{{p}_{l}}{2 {f}_{m l}^{3}} ) {f}^{3} - ( \frac{{q}_{l}}{2} - \frac{3 {p}_{l}}{2 {f}_{m l}} ) f , & ( 0 \leq f \leq {f}_{m l} ) \\ 0 , , & else\end{matrix}\end{matrix}$$
where, H_{Xel}(f) is a low frequency band extension interpolation function for frequency f; k in the right hand side is a natural number ranging from 3 to K; aₖ is a coefficient; fₘₗ is a lowest frequency of the band-limited S-parameter signal; and q₁ and p₁ are derivative values for ensuring the continuity.

10. The method of claim 1, wherein the generating of the extrapolation function includes:
confirming whether continuity between the real part of the band-limited S-parameter signal and the extrapolation function is ensured;
deriving a coefficient for ensuring causality;
adjusting an extended frequency and setting an optimal frequency;
determining whether the extrapolation function diverges; and
generating a high frequency band extrapolation function.

11. The method of claim 10, wherein the adjusting of the extended frequency and setting of the optimal frequency is performed so that the extended frequency is adjusted until the same reaches a limit range and the optimal frequency is set when the extrapolation function does not diverge as a result of performing the determining whether the extrapolation function diverges.

12. The method of claim 10, wherein the generating of the high frequency band extrapolation function is performed so as to be defined as an equation below:
$${H}_{Xeh} ( f ) = \{ \begin{matrix}{\sum }_{j = 3}^{J} {b}_{j} \cdot \{ \begin{matrix}{( f - {f}_{e} )}^{2 j - 1} - ( j - 1 ) \cdot {f}_{b}^{2 ( j - 2 )} \cdot {( f - {f}_{e} )}^{3} + \\ ( j - 2 ) \cdot {f}_{b}^{2 ( j - 1 )} \cdot ( f - {f}_{e} )\end{matrix} \} + \\ \begin{matrix}( \frac{{q}_{h}}{2 {f}_{b}^{2}} + \frac{{p}_{h}}{2 {f}_{b}^{3}} ) {( f - {f}_{e} )}^{3} - ( \frac{{q}_{h}}{2} + \frac{3 {p}_{h}}{2 {f}_{b}} ) ( f - {f}_{e} ) , & ( {f}_{mh} \leq f \leq {f}_{e} ) \\ 0 , & else\end{matrix}\end{matrix} \\ where , {f}_{b} = {f}_{e} - {f}_{mh}$$
where, H_{Xeh}(f) is a high frequency band extension extrapolation function for frequency f; j is a natural number ranging from 3 to J; bⱼ is a coefficient; fₘₕ is a highest frequency of the band-limited S-parameter signal; and qₕ and pₕ are derivative values for ensuring the continuity.
